(19) United States
(12) Patent Application Publication
(10) Pub. No.: US 2014/0272115 A1
(43) Pub. Date: Sep. 18, 2014

(54) FIRE RETARDANT COATING FOR HALOGEN FREE CABLES

(71) Applicant: General Cable Technologies Corporation, Highland Heights, KY (US)

(72) Inventors: Tyrel P. Shaffer, Myersville, MD (US); Michelle M. Alex, Canton, OH (US); Eric W. Bates, Lafayette, IN (US); Subramanya Kishore Avadhanula Venkata, Navi Mumbai (IN); Srinivas Siripurapu, Carmel, IN (US)

(73) Assignee: General Cable Technologies Corporation, Highland Heights, KY (US)

(21) Appl. No.: 14/213,044

(22) Filed: Mar. 14, 2014

Related U.S. Application Data
(60) Provisional application No. 61/792,610, filed on Mar. 15, 2013.

(51) Int. Cl. G02B 6/44; H01B 7/295; H01B 13/06

(52) U.S. Cl. CPC G02B 6/4401; G02B 6/4486; H01B 13/06; H01B 7/295
USPC 427/118; 385/100; 385/101; 427/163.2; 174/120 R

(57) ABSTRACT

Cables having a conductor with a polymeric covering layer and a non-extruded coating layer made of a material based on a liquid composition including a polymer resin and a fire retardant. Methods of making cables are also provided.

### CROSS-REFERENCE TO RELATED APPLICATION

The present application claims priority of U.S. provisional application Ser. No. 61/792,610, filed Mar. 15, 2013, and hereby incorporates the same application herein by reference in its entirety.

### TECHNICAL FIELD

The present disclosure relates to cover (insulation or jacket) compositions for wires or cables having a coating thereon that provides fire retardant properties to the cable.

### BACKGROUND

Polymeric materials have been utilized in the past as electrical insulating materials for electrical cables. In services or products requiring long-term performance of an electrical cable, such polymeric materials, in addition to having suitable dielectric properties, must be durable. For example, polymeric insulation utilized in building wire, electrical motor or machinery power wires, or underground power transmitting cables, must be durable for safety and economic necessities and practicalities.

The most common polymeric insulators are made from either polyethylene homopolymers or ethylene-propylene elastomers, otherwise known as ethylene-propylene-rubber (EPR) and/or ethylene-propylene-diene ter-polymer (EPDM). Lead, such as lead oxide, has been used as a water tree inhibitor and ion scavenger in filled EPR or EPDM insulation; however, lead is toxic.

Typically, fire retardants are used in the insulation to provide flame resistance. Halogenated additives (compounds based on fluorine, chlorine or bromine) or halogen containing polymers (e.g. polyvinyl chloride) are capable of giving fire-resistant properties to the polymer which forms the insulation, but have the drawback that the decomposition products of halogenated compounds are corrosive and harmful. As a result, the use of halogens, especially for uses in closed locations, is not recommended.

Alternatively, or in combination with the halogens, a flame retardant additive, such as antimony oxides, aluminum hydroxide, magnesium hydroxide, and phosphorus flame retarders, can be added to an appropriate insulation polymer. However, the addition of too much flame retardant additive has adverse effects on electrical and/or physical properties of the insulation. Thus, it is not always appropriate to increase the flame resistance of a cable cover by adding more flame retardant additive. Up to a point, the cable will not meet its electrical and/or physical requirements.

Therefore, there remains a need for improving flame resistance of a cable without adversely affecting its electrical and/or physical properties.

### SUMMARY

In accordance with one embodiment, a cable includes a conductor, a polymeric covering layer and a non-extruded coating layer made of a material based on a liquid composition. The liquid composition includes a polymer resin and a fire retardant.

In accordance with another embodiment, a method of making a cable includes providing a conductor covered with a polymeric covering layer, coating an outer surface of the polymeric covering layer with a liquid composition and curing a liquid polymer resin. The liquid composition includes a polymer resin and a fire retardant.

### BRIEF DESCRIPTION OF THE DRAWINGS

FIG. 1 is a cross-section of one embodiment of the present disclosure.

FIG. 2 is a cross-section of another embodiment of the present disclosure.

### DETAILED DESCRIPTION

The present disclosure provides a cable with improved flame resistance without adversely affecting the electric or physical properties of the cable. A cable can contain a conductor, a polymeric covering layer (e.g., a jacket or insulation), and a coating layer on the outer surface of the polymeric covering layer. The coating layer can be made of a material based on a liquid composition containing a polymer resin and a fire retardant additive. In certain embodiments, the polymer resin can be an epoxy or urethane liquid composition. The coating layer is not an extruded layer, because the polymer resin liquid composition is not amenable to extrusion due to its low viscosity. The coating layer can impart improved flame resistance when compared to a cable without the coating layer, but does not adversely affect the electrical or physical properties of the cable.

The present disclosure also provides a method of making a cable with improved flame resistance. For example, a cable capable of passing a FT-2 and/or VW-1 flame rating. A conductor can first be covered with a covering layer made of a polymeric material. The covering is generally used in the art as a cable jacket or insulation layer, which can be extruded over the conductor. The covering can then be coated with a coating layer made of a liquid material containing a polymeric resin and a fire retardant additive. In certain embodiments, the polymeric material for the covering layer can be halogen-free.

The coating layer can allow the cable to pass rigorous flame resistant requirements, such as FT-2 and/or VW-1 rating, without adversely affecting the electrical and/or physical properties of the cable.

FIG. 1 shows one embodiment of the present disclosure. In that embodiment, the cable 100 includes a conductor 102, an insulation 104 covering the conductor 102, and a coating layer 106.

FIG. 2 show another embodiment of the present disclosure. In that embodiment, the cable 200 includes a plurality of insulated conductors 202 which are covered with a jacket 204.

In accordance to an embodiment of the present disclosure, instead of applying the coating layer directly on to the cover (as shown in FIGS. 1 and 2), it is possible to apply the coating layer on to a surface of a tape, which can then be wrapped over the cover layer. This way, the coating layer can be applied on to a flat surface of a tape and, in some circumstances, may be a simpler process than coating a cylindrical object.

In certain embodiments, a conductor can be an optical conductor or an electrical conductor. An optical conductor, can be, e.g. an optical fiber known in the art. An electrical conductor can be, e.g. a copper or aluminum conductor known in the art.

A cover can include any insulation or jacket generally used in the art. Preferably, the cover is a halogen free polymer, such as a polyolefin based polymer. Polyolefins, as used herein, are polymers produced from alkenes having the general formula CₙH₂ₙ. Within the broad definition above, non-limiting examples of polyolefins suitable for the present disclosure include polyethylene (including low-density (LDPE), high-density, high molecular weight (HDPE), ultra-high molecular weight (UHDPE), linear-low-density (LLDPE), very-low density, etc.), maleated polypropylene, polypropylene, polybutylene, polyhexalene, polyoctene, and copolymers thereof, and ethylene-vinyl-acetate (EVA) copolymer, and mixtures, blends or alloys thereof. The preferred base polymer is EVA, ethylenepropylene rubber (EPR), ethylene-propylene-diene ter-polymer (EPDM), or ethylene-alkylene copolymer (EAM).

The cover can also include a blend of one or more polyolefins and other polymers. In certain embodiments, the cover can further include a maleic anhydride modified polyolefin and a butadiene-styrene copolymer. Maleic anhydride modified polyethylene can be used in the composition, and is available commercially as Lotader, Fusabond, Orevac, or Elvaloy. The butadiene-styrene copolymer preferably has a styrene content of about 20-30% by weight. In one embodiment, the styrene copolymer can include, for example, a block copolymer made from styrene and butadiene. In another embodiment, the styrene copolymer contains a random arrangement of styrene and butadiene. In certain embodiments, the styrene copolymer is a random arrangement of styrene and ethylene Butadiene-styrene copolymer is available commercially, for example, as Ricon, Solprene, Synpol, Stereon, or Pliolite.

The cover may also include other additives that are generally used in insulated wires or cables, such as a flame retardant, a filler, an antioxidant, a processing aid, a colorant, a crosslinking agent, and a stabilizer in the ranges commonly used in the art.

One cover composition is disclosed in co-pending U.S. patent application Ser. No. 13/713,535, filed Dec. 13, 2012, the disclosure of which is incorporated herein by reference. That application discloses a lead-free, halogen-free, and antimony-free cover composition containing (a) a polyolefin; (b) a maleic anhydride modified polyolefin; (c) a butadiene-styrene copolymer; (d) a non-halogen flame retardant; and (e) a silane compound. The silane compound can include, but is not limited to, γ-methacryloxypropyltrimethoxysilane, methyltriethoxysilane, methyltris(2-methoxyethoxy)silane, dimethyldiethoxysilane, vinyltris(2-methoxyethoxy)silane, vinyltrimethoxysilane, vinyltriethoxysilane, octyltriethoxysilane, isobutyltriethoxysilane, isobutyltrimethoxysilane, propyltriethoxysilane, and mixtures or polymers thereof. In certain embodiments, the flame retarder can be magnesium hydroxide, such as, for example, untreated, low ionic content magnesium hydroxide. In certain embodiments, magnesium hydroxide can have an average particle size of about 0.5 to 3.0 microns, in certain embodiments, an average particle size of about 0.8 to 2.0, and in certain embodiments, an average particle size of about 0.8 to 1.2. Commercially available magnesium hydroxide includes Zerogen, Magnifin, ICL FR20, and Kisuma.

The coating can be made of a material based on a liquid composition containing a polymer resin and a fire retardant additive. Because the liquid composition has a relatively low viscosity, the coating is not extruded. Rather, the coating layer can be applied by painted, sprayed, or dip process as detailed below. The liquid coating material can include a polymer resin, a fire retardant additive, and a solvent. The fire retardant can be dispersed in the resin and solvent, e.g. using techniques known in the art. The solvent can include a mixture or a single solvent. The solvent can include, but is not limited to, water, n-butyl glycidyl ether (BGE), isopropyl glycidyl ether (IGE), phenyl glycidyl ether (PGE), and mixtures thereof. In certain embodiments, a water emulsion system can be used. The liquid composition can also include dispersants, anti-settling aids, wetting agents, UV stabilizers, heat stabilizers, and/or combinations thereof.

The polymer resin can include an epoxy or urethane liquid composition. In certain embodiments, two parts or single part epoxy or urethane compositions can be used. Two part systems generally include a first part that includes the resin and a second part that includes a curing agent. When the two parts are mixed, the composition can be cured to form a thermoset. When using the two part system, it can be desirable to use a ratio of resin:curing agent that can be sufficient to ensure that the thermoset coating has the desired flexibility for the cable and tack-free curing.

In addition to the polymer resin, the coating composition can also include a fire retardant additive, such as a non-halogen flame retardant. A non-halogen flame retardant, can include, for example, phosphinates (e.g. aluminum phosphinate), phosphonates, phosphates (e.g. melamine pyrophosphate, ammonium polyphosphate, ethylenediamine-o-phosphate), phosphoric acid, polyphosphoric ester, or mixtures thereof. The additives can include synergists, such as melamine, dipentaerythritol, melamine cyanurate, zinc borate, and mixtures thereof.

The covering layer can be applied on to the cable using methods known in the art. Usually, the covering layer can be extruded on to a bare conductor to form an insulation layer, or on to at least one insulated conductor to form a jacket. Extrusion methods for applying the covering layer are well-known in the art.

The coating mixture can be applied to an outer surface of the covering layer, either directly or after the surface has been prepared. Preparation may include cleaning the outer surface of the covering or treating that surface to improve the adhesion of the coating. The preparation can be as simple as cleaning with soap and water to corona treatment or flame treatment. The cover can be wiped with isopropyl alcohol, dried, and heated. The heating can take place in an oven heated to about 200 to about 400° F. for about 1 second to about 1 minutes in one embodiment, in certain embodiments for about 2 seconds to about 30 seconds, an in certain embodiments for about 3 seconds to about 10 seconds.

In an embodiment, a coating mixture composition can be applied by spraying. A spray gun can be used with 10-45 psi pressure, and controlled through air pressure. The spray gun nozzle can be placed at opposite direction of the conductor (at approximately 90° angle) to get a uniform coating on conductor product. In certain cases, two or more guns can be used to get more efficient coatings. The coating thickness can be controlled by the admixture viscosity, gun pressure, and conductor line speed. During the coating application, the temperature can be maintained at about room temperature to about 250° C. depending on the material of the covering and/or the coating.

Alternatively, the coating can be applied to the cable by dipping or painting. Here, the covered cable can be dipped into the liquid coating mixture to allow the mixture to completely coat the conductor. The cable can then be removed from the coating mixture and cured. In painting, the liquid coating mixture can be painted on to the outer surface of the covering layer using a brush or a roller.

After application, the coating can be cured/dried at either at room temperature or at elevated temperatures up to 250° C. for about 10 seconds to about 60 minutes in one embodiment, in certain embodiments for about 10 seconds to about 15 minutes, an in certain embodiments for about 10 seconds to about 3 minutes. Curing/drying can be on-line and/or off-line. In certain embodiments, on-line curing can be sufficient to achieve a tack-free coating. The cable can then be rolled up and further cured off-line to achieve complete cure.

The coating process can be automated with robotic systems. The automated process can function in three steps: 1) preparing the outer surface of the covering layer; 2) applying the coating layer on the outer surface of the covering layer; and 3) curing the coating layer. The coating process can be batch, semi-batch, or continuous, with continuous processing being generally more effective for automation. The line speed for the continuous process can be about 10 to about 3000 feet/minute. In certain embodiments, the speed can be about 10-750 feet/minute, in certain embodiments, about 300-600 feet/minute, and in certain embodiments, about 400-500 feet/minute. However, for data cables, the line speed can be much greater, for example, 1000-3000 feet/minute, and in certain embodiments 1500-2500 feet/minute.

Once completely dried/cured, the coating layer can have a thickness of about 5 mils or less, in certain embodiments from about 1 mil to about 4 mils, an in certain embodiments from about 2 mils to about 3 mils. The dried/cured coating layer can also contain up to about 60% fire retardant, in certain embodiments, from about 20% to about 40%, and in certain embodiments from about 30% to about 35%. That concentration can be much higher than that of the liquid coating composition due to evaporation of the volatile components during the drying/curing process. The dried/cured coating can be sufficiently flexible so that, when the cable is wrapped around a mandrel having the same size as the cable diameter, the coating does not crack or comes apart on the cable.

The coating layer can improve flame resistance of the cable, for example, permitting it to pass FT-2 and/or VW-1 rating, without adversely affecting the electrical and/or physical properties of the cable.

Without further description, it is believed that one of ordinary skill in the art can, using the preceding description and the following illustrative example, make and utilize the compounds of the present disclosure and practice the claimed methods. The following examples are given to illustrate the present disclosure. It should be understood that the invention is not to be limited to the specific conditions or details described in the examples.

### EXAMPLE 1

A two part epoxy resin containing about 25% (w/w) of an intumescent flame retardant was used (either Intumax EP102 or Intumax EP 200C). Mixes with different ratios of resin (Part A) to curing agent (Part B) was used. A foam paint brush was used to apply the coating on a 14 AWG insulated wire and cured in an over for approximately 30 minutes at a temperature of less than 250° C. The insulation composition for the wire is shown in Table 1.

| | Insulation composition (parts by |
|---|---|
| Components | weight) |
| Metallocene catalyzed polyolefin | 90 |
| Maleic Anhydride grafted polyethylene* | 10 |
| Magnesium Hydroxide | 155 |
| Silane treated kaolin | 30 |
| 50% Silane dispersion in wax | 6.60 |
| Antioxidant | 4.50 |
| Process aid (blend of fatty acids) | 2.00 |
| Polybutadiene styrene copolymer | 6.00 |
| Peroxide | 2.3 |
| Total | 305.7 |

The wires were tested per VW-1 UL specification. The wire was wrapped around a ⅛″ mandrel and observed for cracks. There must be no crack or delamination of the coating for the cable to pass the mandrel test. Table 2 shows the result of the tests (the uncoated cable does not pass the VW-1 test).

TABLE 2

| | | | Mandrel |
|---|---|---|---|
| Sample | Part A:Part B | VW-1 | bend test |
| Intumax EP102 | 100:64 | PASS | FAIL |
| Intumax EP102 | 100:24 | PASS | FAIL |
| Intumax EP102 | 100:16 | 2/3 PASS | PASS |
| Intumax EP 200C | 100:52 | PASS | FAIL |
| Intumax EP 200C | 100:19.5 | PASS | FAIL |
| Intumax EP 200C | 100:13 | PASS | PASS |

An epoxy resin was used (D.E.R 324 Epoxy Resin) with an amine curing agent (Jeffamine D 400 or Jeffamine T 403), a powdered fire retardant additive (Exolit AP750 (ammonium polyphosphate), FP-2100J (nitrogen-phosphorous based flame retardant), or Exolit AP462 (ammonium polyphosphate)), and an additive (Melamine or SF 1706 Amino Silicon). A foam paint brush was used to apply the coating on a 14 AWG insulated wire (insulation as shown in Table 1) and cured in an over for approximately 30 minutes at a temperature of less than 250° C. The wires were tested per VW-1 UL specification. A mandrel test as described above was also performed. Table 3 shows the result of the tests (the uncoated cable does not pass the VW-1 test):

TABLE 3

| Resin | Other | Amine | FR Additive | | Mandrel |
|---|---|---|---|---|---|
| (parts) | (parts) | (parts) | (parts) | VW-1 | bend test |
| 45.48 | Melamine | Jeffamine D 400 | Exolit AP750 | 2/3 PASS | PASS |
| | (4) | (26.15) | (24.36) | | |
| 47.17 | SF 1706 Amino Silicon | Jeffamine D 400 | FP-2100J | PASS | FAIL |
| | (1.36) | (27.13) | (24.34) | | |
| 53.12 | SF 1706 Amino Silicon | Jeffamine T 403 | Exolit AP750 | PASS | FAIL |
| | (1.08) | (21.53) | (24.28) | | |
| 48.04 | — | Jeffamine D 400 | FP-2100J | 2/3 PASS | FAIL |
| | | (27.62) | (24.34) | | |
| 48.04 | — | Jeffamine D 400 | Exolit AP462 | 2/3 PASS | FAIL |
| | | (27.62) | (24.34) | | |
| 48.04 | — | Jeffamine D 400 | Exolit AP750 | PASS | PASS |
| | | (27.62) | (24.34) | | |
| 47.17 | SF 1706 Amino Silicon | Jeffamine D 400 | Exolit AP462 | PASS | PASS |
| | (1.36) | (27.13) | (24.34) | | |

### EXAMPLE 2

A two part polyurethane (Durabak) was used with a curing agent (CA) and a fire retardant (Exolit AP750, Exolit AP462, AC3WM (activated organo phosphate blend), or FP2100J). A foam paint brush was used to apply the coating on a 14 AWG insulated wire (insulation as shown in Table 1) and cured in an over for approximately 30 minutes at a temperature of less than 250° C. The wires were tested per VW-1 UL specification. A mandrel test as described above was also performed. Table 4 shows the result of the tests (the uncoated cable does not pass the VW-1 test:

TABLE 4

| | | Mandrel |
|---|---|---|
| Formulation | VW-1 | bend test |
| Durabak + CA + AP750 | pass | pass |
| Durabak + CA + AP462 | pass | pass |
| Durabak + CA + AC3WM | 2/3 pass | pass |
| Durabak + CA + FP2100J | pass | pass |

The foregoing description of embodiments and examples has been presented for purposes of illustration and description. It is not intended to be exhaustive or limiting to the forms described. Numerous modifications are possible in light of the above teachings. Some of those modifications have been discussed and others will be understood by those skilled in the art. The embodiments were chosen and described for illustration of various embodiments. The scope is, of course, not limited to the examples or embodiments set forth herein, but can be employed in any number of applications and equivalent devices by those of ordinary skill in the art. Rather it is hereby intended the scope be defined by the claims appended hereto. Also, for any methods claimed and/or described, regardless of whether the method is described in conjunction with a flow diagram, it should be understood that unless otherwise specified or required by context, any explicit or implicit ordering of steps performed in the execution of a method does not imply that those steps must be performed in the order presented and may be performed in a different order or in parallel.

What is claimed is:

1. A cable comprising:
a. a conductor;
b. a polymeric covering layer; and
c. a non-extruded coating layer made of a material based on a liquid composition, the liquid composition comprising a polymer resin and a fire retardant.

2. The cable of claim 1, wherein the polymeric covering layer is formed of a halogen-free material.

3. The cable of claim 1, wherein the non-extruded coating layer comprises a thickness of about 5 mils or less.

4. The cable of claim 3, wherein the non-extruded coating layer comprises a thickness of about 1 mil to about 4 mils.

5. The cable of claim 1 capable of passing at least one of a FT-2 flame rating and a VW-1 flame rating.

6. The cable of claim 1, wherein the conductor comprises an electrical conductor.

7. The cable of claim 1, wherein the polymeric covering layer comprises a polyolefin.

8. The cable of claim 7, wherein the polyolefin comprises one or more of polyethylene, low-density polyethylene, high-density polyethylene, high molecular weight polyethylene, ultra-high molecular weight polyethylene, linear-low-density polyethylene, very-low density polyethylene, maleated polypropylene, polypropylene, polybutylene, polyhexalene, polyoctene, including any copolymers thereof, ethylene-vinyl-acetate copolymer, ethylenepropylene rubber, ethylene-propylene-diene ter-polymer, ethylene-alkylene copolymer, or a copolymer or blend thereof.

9. The cable of claim 1, wherein the polymer resin comprises an epoxy or urethane.

10. The cable of claim 1, wherein the fire retardant comprises an intumescent compound.

11. The cable of claim 1, wherein the fire retardant comprises an inorganic flame retardant.

12. The cable of claim 1, wherein the non-extruded coating layer comprises about 60% or less of the flame retardant.

13. The cable of claim 1, wherein the non-extruded coating layer does not crack or delaminate when the cable is wrap around a mandrel having the same size as the diameter of the cable.

14. A method of making a cable, the method comprising:
a. providing a conductor covered with a polymeric covering layer;
b. coating an outer surface of the polymeric covering layer with a liquid composition, the liquid composition comprising a polymer resin and a fire retardant; and
c. curing the liquid polymer resin.

15. The method of claim 14, wherein the polymeric covering layer is formed from a halogen-free material.

16. The method of claim 14, wherein the non-extruded coating layer comprises a thickness of about 5 mils or less.

17. The method of claim 16, wherein the non-extruded coating layer comprises a thickness of about 1 mil to about 4 mils.

18. The method of claim 14, wherein the cable is capable of passing at least one of a FT-2 flame rating and a VW-1 flame rating.

19. The method of claim 14, wherein the conductor comprises an electrical conductor.

20. The method of claim 14, wherein the polymeric covering layer comprises a polyolefin.

21. The method of claim 20, wherein the polyolefin comprises one or more of polyethylene, low-density polyethylene, high-density polyethylene, high molecular weight polyethylene, ultra-high molecular weight polyethylene, linear-low-density polyethylene, very-low density polyethylene, maleated polypropylene, polypropylene, polybutylene, polyhexalene, polyoctene, including any copolymers thereof, ethylene-vinyl-acetate copolymer, ethylenepropylene rubber, ethylene-propylene-diene ter-polymer, ethylene-alkylene copolymer, or a copolymer or blend thereof.

22. The method of claim 14, wherein the polymer resin comprises an epoxy or urethane.

23. The method of claim 14, wherein the fire retardant comprises an intumescent compound.

24. The method of claim 14, wherein the fire retardant comprises an inorganic fire retardant.

25. The method of claim 14, wherein the liquid composition further comprises a solvent.

26. The method of claim 14, wherein the coating of the outer surface of the polymeric covering layer is accomplished by spraying, dipping, or painting.

27. The method of claim 14, wherein the coating of the outer surface of the polymeric covering layer takes place from about room temperature to about 250° C.

28. The method of claim 14, wherein prior to coating the outer surface of the polymeric covering layer, the outer surface of the polymeric covering layer is cleaned and dried.

29. The method of claim 14, wherein curing the liquid polymer resin takes place from about room temperature to about 250° C. or less.

30. The method of claim 14, wherein the coating of the outer surface of the polymeric covering layer and curing the liquid polymer resin are automated.
